(19) United States
(12) Patent Application Publication
(10) Pub. No.: US 2020/0389962 A1
(43) Pub. Date: Dec. 10, 2020

(54) LUMINAIRE HEALTH MONITORING

(71) Applicant: OPEN PLATFORM SYSTEM LLC, Garden City, ID (US)

(72) Inventor: Dean Andrew Wilkinson, Emmett, ID (US)

(21) Appl. No.: 16/896,180

(22) Filed: Jun. 8, 2020

Related U.S. Application Data
(60) Provisional application No. 62/857,899, filed on Jun. 6, 2019.

(51) Int. Cl. H05B 45/50; H05B 47/19

(52) U.S. Cl. CPC H05B 45/50; H05B 47/19

(57) ABSTRACT

An LED array having a driver connected to a sensor. The sensor can be either integral with a controller or separate from the driver and in communication with the controller. The sensor is configured to sense one or more of the temperature, forward voltage, LED voltage, and/or total driver power. The controller is preferably configured for wireless connectivity with a local computer, such as by Bluetooth® or configured for an internet connection to allow for remote monitoring of the LED array. The controller can be configured to compare the sensed voltage, temperature, forward voltage, and/or driver power and compare it to a programmed and/or sensed base and notify of a fault. Alternatively, the controller can be connected to a computer via internet and/or wireless signal (such as Bluetooth®) to compare the sensed condition to a normal condition to determine if a fault has occurred.

### PRIORITY/CROSS-REFERENCE TO RELATED APPLICATIONS

This application claims the benefit of U.S. Provisional Application No. 62/857,899, filed Jun. 6, 2019, the disclosure of which is incorporated by reference.

### TECHNICAL FIELD

The disclosure generally relates to the field of lighting. Particular embodiments relate to monitoring the health of a luminaire.

### BACKGROUND

LED light fixtures often suffer from partial failures of LEDs, or from driver degradation that ultimately leads to catastrophic failure. Unanticipated failures require unplanned maintenance to replace the failed luminaires. Given the high cost of servicing lights, it would be better to know in advance of impending or partial failures in order to plan scheduled maintenance.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

LED arrays driven by a constant-current driver will have a typical forward voltage at any given temperature. By monitoring the LED voltage and driver temperature, and knowing the expected LED voltage for that temperature with a tolerance range from characterization data, it is possible to detect partial LED failures and/or driver failures that result in a change in the LED forward voltage which takes it outside the normal range. Other failure modes such as flickering or flashing of the driver output can also be detected through monitoring of the LED forward voltage over time. Monitoring and detection of failures will typically be performed by a controller that interfaces with a driver than can provide digital data on temperature, LED voltage, and/or total driver power. The driver is connected to one or more sensors and/or has one or more integral sensors for sensing the LED forward voltage, the temperature, and/or the total driver power.

When strings of LEDs fail open-circuit, the current flowing through the remaining strings increases, which will cause the overall LED forward voltage to increase. This increase can be detected if enough strings fail to produce a significant rise on the overall LED forward voltage for the array. This can be detected by a sensor. Alternately, LED strings that have complete or partial shorts will pull down the overall LED forward voltage which can also be detected by a sensor. In the case of shorting, the strings that are shorted will pull too much current, which will likely result in an eventual open-circuit failure of the shorted strings.

What is disclosed is an LED array having a driver. The driver is connected to a sensor. The sensor can be either integral with a controller or separate from the driver and in communication with the controller. The sensor is configured to sense one or more of the temperature, forward voltage, LED voltage, and/or total driver power. The controller is preferably configured for wireless connectivity with a local computer, such as by Bluetooth® or configured for an internet connection to allow for remote monitoring of the LED array. Alternatively or in addition to the remote connectivity the LED array can be configured with an alternate mechanism for providing notice of the LED and/or driver failures by providing illumination of a warning light and/or by producing an audible signal when prompted.

The controller can be configured to compare the sensed voltage, temperature, forward voltage, and/or driver power and compare it to a programmed and/or sensed base and notify of a fault. Alternatively, the controller can be connected to a computer via internet and/or wireless signal (such as Bluetooth®) to compare the sensed condition to a normal condition to determine if a fault has occurred.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 depicts a flow chart of an embodiment of an LED array monitoring system.

FIG. 2 depicts a flow chart of an embodiment of LED array monitoring system.

FIG. 3 depicts a table illustrating the forward voltage vs. the junction temperature.

FIG. 4 depicts a table illustrating the forward voltage vs the current voltage.

### DISCLOSURE

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

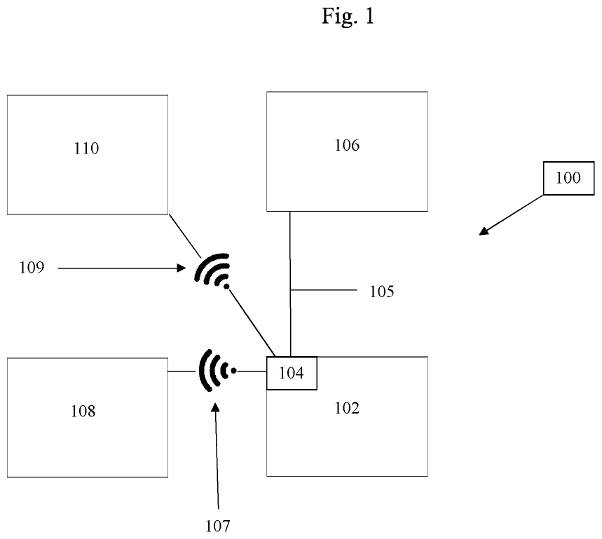

FIG. 1 illustrates a flow chart of an embodiment of an LED array monitor 100. The LED array monitor 100 has a driver 102 with a controller 104 configured to connect to a sensor. The sensor can be either integral with a controller or separate from the driver and in communication with the controller. FIG. 1 illustrates the controller 104 integrally connecting 105 with sensor 106. FIG. 1 also illustrates the controller alternatively establishing a wireless connection 107 with sensor 108. The sensors 106, 108 are configured to sense one or more of the temperature, forward voltage, LED voltage, and/or total driver power. The sensors 106, 108, communicate to the controller 104 any failure of the LED array or driver 102 failures.

The controller 104 is preferably configured for wireless connectivity 109 with a local computer 110, such as by Bluetooth® or configured for an internet connection to allow for remote monitoring of the LED array.

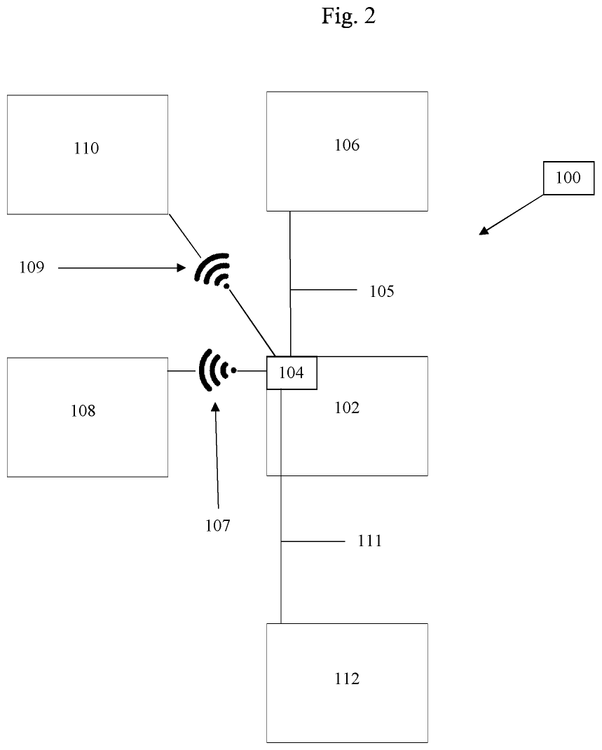

FIG. 2 illustrates an alternate mechanism 112 for providing notice of the LED and/or driver failures. The controller 104 receives failure information by the sensors 106, 108 and communicates 111 with the alternate mechanism 112 to provide notice. The alternate mechanism can include, but is not limited to an illumination of a warning light and/or producing an audible signal when prompted. The controller 104 can also communicate with another router or computer to provide notice of the system failures.

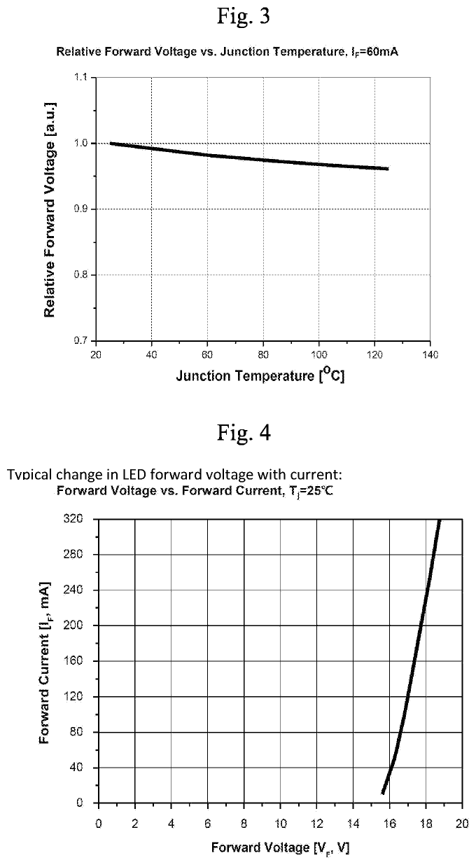

FIG. 3 depicts a table illustrating the forward voltage vs. the junction temperature.

FIG. 4 depicts a table illustrating the forward voltage vs the current voltage.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. An LED array monitoring system comprising:
an LED array, said LED array comprising a driver, wherein said driver is operated by a controller;
wherein said controller is configured to connect to a sensor, wherein said sensor and said controller are in communication;
wherein said sensor is configured to provide information about a condition sensed to said controller;
wherein the controller is configured to compare the information sensed with a reference information to determine if there is a fault in said system;
wherein said controller is configured to communicate with a computer to notify said computer of said fault in said system.

2. The LED array monitoring system of claim 1, wherein said sensor is configured to sense temperature.

3. The LED array monitoring system of claim 1, wherein said sensor is configured to sense forward voltage.

4. The LED array monitoring system of claim 1, wherein said sensor is configured to sense LED voltage.

5. The LED array monitoring system of claim 1, wherein said sensor is configured to sense temperature.

6. The LED array monitoring system of claim 1, wherein said sensor is wirelessly connected to said controller.

7. The LED array monitoring system of claim 1, wherein said controller is configured for wireless connection with a remote computer configured for monitoring the LED array.
